(19) United States
(12) Patent Application Publication
(10) Pub. No.: US 2009/0214196 A1
(43) Pub. Date: Aug. 27, 2009

(54) High efficiency direct electric heating system

(76) Inventor: Jarle Jansen Bremnes, Fredrikstad (NO)

Correspondence Address: SOFER & HAROUN LLP., 317 MADISON AVENUE, SUITE 910, NEW YORK, NY, 10017, US

(21) Appl. No.: 12/321,862

(22) Filed: Jan. 26, 2009

(30) Foreign Application Priority Data
Feb. 15, 2008 (NO) 2008 0833

(51) Int. Cl. F24H 1/10; H05B 3/00

(52) U.S. Cl. 392/480; 29/611

(57) ABSTRACT

A direct electric heating system for subsea steel pipeline with a piggyback cable arranged on the pipeline, where at least one shell-type magnetic core encompasses the pipeline with its piggyback cable. The shell-type magnetic core may be continuously or discretely arranged on the pipeline. The shell-type magnetic core may be applied around the pipeline with piggyback cable. This direct electric heating system improves the pipeline current ratio through introduction of magnetic coupling between piggyback cable and pipeline thus significantly reducing power consumption and current in sea water.

### RELATED APPLICATION

This application claims the benefit of priority from Norwegian Patent Application No. 2008 0833, filed on Feb. 15, 2008, the entirety of which is incorporated by reference.

### FIELD OF THE INVENTION

The present invention generally relates to the field of direct electric heating (DEH) systems typically used for subsea oil or condensate pipelines. More specifically, it relates to a DEH system comprising a magnetic core encompassing the pipeline in order to increase the pipeline current and reduce the current flowing through the sea.

### DESCRIPTION OF THE RELATED ART

The temperature of the oil or condensate in the underground reservoirs is typically about 90° C. The oil or condensate well stream contains several liquid substances that freeze when the temperature drops. This is a problem when the pipes are cooled in seawater, particularly during a shutdown of production, which causes the flow in the line to be impeded or even blocked due to the formation of hydrates or wax plugs. To solve this problem chemical treatments are mainly used. However, this method has considerable operational costs and presents a risk to the environment should a leakage occur.

As an alternative to chemical treatment, electric heating has been suggested. Three methods may be used: i) electric heating cables, ii) electromagnetic induction heating, or iii) direct electric heating of the pipeline. The first alternative is found to be rather inefficient, and the second very expensive.

The direct heating system is based on the fact that an electric current in a metal conductor generates heat due to ohmic loss. The power supply is then connected directly to the electrically insulated steel pipe.

For heating of oil or gas pipelines in order to prevent hydrate and ice formation on the pipeline walls, the present applicant has developed a direct electrical heating system that is described, inter alia, in British patent specification No. 2.373.321 A. For current supply to such a heating system a common practice is to install a current supply cable as a so called “piggyback” cable, which is traditionally made simultaneously with the laying of the pipeline. More specifically such a single-core cable is strapped to the pipeline during installation thereof. The return current should of course as a whole flow through the pipeline walls in order to generate the heating effect aimed at.

GB 2 341 442 A describes an example of a heating system which can be used for pipelines on the sea floor. In this system, the metallic tube of the pipeline is electrically and thermally insulated and connected to a power supply which feeds a current through the metallic tube, whereby an efficient heating is achieved with alternating current.

U.S. Pat. No. 6,509,557—Apparatus and method are provided for electrically heating subsea pipelines. An electrically insulating layer is placed over the pipe in the segment of the pipeline to be heated and electrical current is caused to flow axially through the steel wall of the pipe. In one embodiment (end fed), an insulating joint at the host end of the pipeline is used to apply voltage to the end of the segment. At the remote end an electrical connector is used to conduct the electrical current to a return cable or to a seawater electrode. A buffer zone of the pipeline beyond the remote end is provided. Separate electrical heating may also be applied in the buffer zone. Electrical chokes may be used in different arrangements to decrease leakage current in the pipeline outside the heated segment. In another embodiment (center fed), voltage is applied at or near the midpoint of the segment to be heated through an electrical connector and no insulating joint is used. Buffer zones, heating of buffer zones and electrical chokes may also be employed in this embodiment.

The current implementation of Direct Electrical Heating (DEH) for subsea pipelines is based on a so-called ‘open’ configuration. In this context, this means ‘open to contact with sea water’, i.e., the pipeline is not electrically insulated from the sea water. This means that there is electric contact between pipeline and sea water at both ends of the pipeline (cable connection points). Often, the pipeline will also have anodes distributed along its length, thus introducing additional contact points between pipeline and sea water.

As a consequence of the above, the current supplied via the piggyback cable into an open DEH system is split into two components:
a) The component flowing in the metallic pipeline, thus causing the desired heating effect.
b) One component flowing in sea water, parallel to the pipeline. This component is unwanted, as it does not contribute to pipeline heating, while it does increase the current rating of the cables as well as the power rating of the overall system.

The technical challenge is thus to find a method of shifting current from sea water into the pipeline. However, it is considered crucial to maintain the ‘open’ system philosophy, i.e. not introduce any requirements with respect to electrical insulation for the pipeline (relative to sea water).

In the best already existing solutions to this problem, the pipeline current will typically have an order of magnitude around 60%-70% of the piggyback cable current, while the corresponding current flowing through sea water will be 40%-30%.

The efficiency of a state-of-the-art DEH system is thus relatively poor. The need to supply a considerably higher cable current to obtain the desired pipeline current and heating effect implies higher cable cost and/or cable power loss. However, the most important impact from the end users point of view is that the topside equipment becomes bulky and heavy. If a larger portion of the supplied cable current could be made to flow inside the pipeline, the technical and economical consequences at the topside end would be considerable.

As an example, if it is possible to improve the pipeline current ratio from 60% to 85% (relative piggyback cable current), then this would reduce the piggyback cable supply current to approximately 65% (same pipeline current and heating obtained). Furthermore, the topside power requirement would also be reduced by 35%-40%, implying massive savings in volume and weight of topside equipment.

Relevant experience with similar problems is related to railway power systems. Most railways are powered by single-phase, high-voltage, Alternating Current (AC). Power is supplied to trains via the overhead contact line, while the rail itself can be used as the second conductor needed to close the electric circuit. For a number of practical and safety reasons the rail needs to remain at a voltage near earth potential. It is also important to limit stray current flow in soil/earth and thus electromagnetic noise along the railway. The rail is most often directly connected to earth at several locations, thus defining a power system very analogue to the DEH system. In order to limit the amount of stray current flow in the soil/earth it is common to install a dedicated return conductor parallel to the railway. This return conductor can then be magnetically connected to the high-voltage supply cables via booster transformers having a 1:1 turn ratio, thus forcing current balance between the current fed into the contact line and the current flowing in the return conductor.

### BRIEF SUMMARY OF THE INVENTION

The present invention relates to a direct electric heating system for subsea steel pipeline comprising a piggyback cable arranged on the pipeline, an electric power supply unit typically arranged at a topside structure and a supply cable where at least one shell-type magnetic core encompasses the pipeline with its piggyback cable.

The at least one magnetic core is constructed from sheaths of electrical steel, similarly to conventional transformer cores. The core lamination shall also ensure that the core itself cannot form a continuous axial electrically conductive path that would shunt the pipeline and drain its current, thus reducing the overall system efficiency. This is the reason why a continuous non-laminated core, e.g. in the form of an axially split magnetic steel tube, cannot not be used to achieve the desired efficiency improvement.

According to one aspect of the invention the shell-type magnetic core may be continuously arranged on the pipeline extending along essentially the whole length of the pipeline. The shell-type magnetic core may be constructed as a thin, continuous element of electrical steel with a thickness typically similar to that of the pipeline. Further, a continuous core may provide protection against mechanical impact for all elements inside.

According to another aspect, the shell-type magnetic core may be discretely arranged on the pipeline extending along a limited part of the pipeline. The shell-type magnetic core may be constructed as a discrete element of electrical steel. The thickness of a discrete element will typically be larger than the thickness of a continuous element for a similar application. A discrete magnetic core may be arranged on every pipeline section as defined by pairs of distributed pipeline anodes. Discrete cores may further comprise two axially divided halves to allow mounting around a continuous pipeline with piggyback cable.

Both for continuous and discrete applications, the shell-type magnetic core will typically be designed not to saturate magnetically at maximum direct electric heating current.

The shell-type magnetic core may have different shapes in the radial cross-section like circular, oval, rectangular or triangular.

Another aspect of the invention is a method for applying a continuous core by winding electrical steel around the pipeline with piggyback cable during installation. For discrete cores, a method for application is presented where the cores are prefabricated in axially divided halves, and the halves are mounted around the pipeline during installation.

A direct electric heating system according to the present invention solves a problem with the prior art solutions by improving the pipeline current ratio through introduction of magnetic coupling between piggyback cable and pipeline thus significantly reducing power consumption and current in sea water.

### BRIEF DESCRIPTION OF THE DRAWINGS

The invention and its advantages may be more easily understood by reference to the following detailed description and attached drawings, in which:

FIG. 1 schematically shows a system overview of a Direct Electric Heating system.

FIG. 2 presents a cross-sectional view of a magnetic shell-core over pipeline with piggyback cable illustrating the principle solution according to the present invention, where the shell-core has a circular or elliptical shape.

FIG. 3 presents a cross-sectional view of a magnetic core over pipeline with piggyback cable, where the shell-core has a rectangular shape.

FIG. 4 presents a cross-sectional view of a magnetic core over pipeline with piggyback cable, where the shell-core has a triangular shape.

FIG. 5 illustrates the positions of the shell-type magnetic core relative to pipeline anodes.

FIG. 6 illustrates the booster principle by presenting magnetic flux lines with non-magnetic core encompassing pipeline.

FIG. 7 illustrates the booster principle by presenting magnetic flux lines with magnetic core encompassing pipeline.

### DETAILED DESCRIPTION OF THE INVENTION

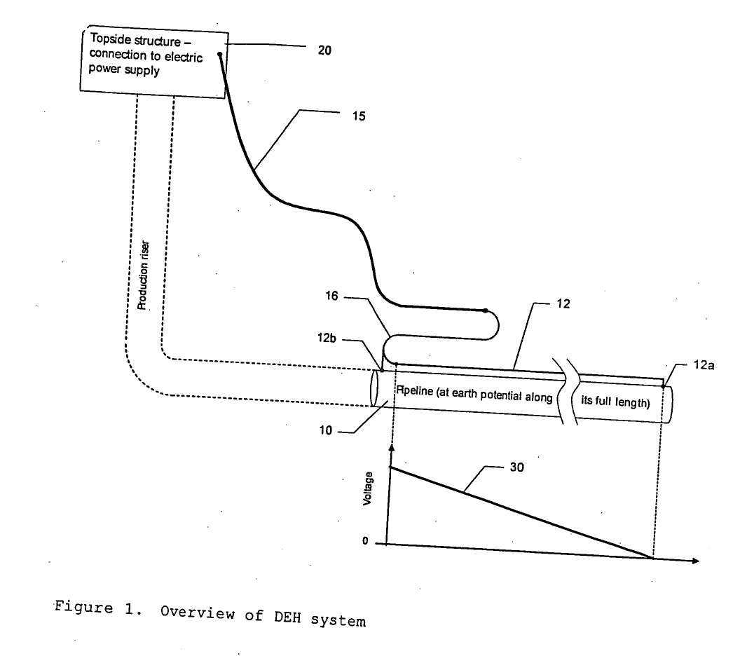

FIG. 1 presents an overview of a pipeline 10 with a direct electric heating system.

An electric power supply unit arranged on a topside structure 20 comprised by the total plant or platform concerned. From the power supply unit there is a two-conductor supply cable or riser cable 15 extended down to the subsea installation concerned. The lower end of cable 16 is at one side connected to the near end 12b of the piggyback cable 12, and on the other side (the other conductor) is connected as shown at 12a to the far end of pipeline 10.

The pipeline 10 has an outer thermal insulation ensuring that crude oil or condensate coming from the well template has a sufficiently low viscosity until it reaches the platform 20. If the pipeline flow is stopped, formation of hydrate plugs and wax deposits occur which can block the pipeline when fluid transportation is to be resumed.

To avoid this problem the pipeline 10 can be heated. One or several sections of the pipeline 10 are connected to the power supply unit installed on the platform 20 with riser cable 15 mentioned above containing one or more conductor pairs. The riser cable 15 is usually protected by armouring and an outer sheathing.

The conductor of the piggyback cable 12 is connected to the far end of the pipeline 10. At 12a there is shown an electric connection point between the piggyback cable 12 and the pipeline 10, for current supply to the latter at this far end.

In FIG. 1 below the pipeline 10, there is a diagram showing a curve 30 representing the piggyback cable voltage with respect to “electric earth”, i.e. the surrounding armouring and sea water. Thus, at the far end 12a of the piggyback cable 12 and the pipeline 10, the curve 30 goes down to zero.

The direct electric heating system layout demands that one of the two conductors is connected to the near end 12b of the pipeline 10 to be heated and earthed at this location. The topside end of the conductor will have a voltage to earth equal to the longitudinal voltage drop along this conductor. The other conductor; is connected to the piggyback cable 12, which runs along the full pipeline 10 length, and is connected to the far end of the pipeline 12a.

As the pipeline is a continuously earthed metallic element from end to end, it is not feasible to insert conventional design booster transformers into the DEH circuit. However, it is feasible to construct a shell-type magnetic core that will encompass both pipeline and piggyback cable—with or without a Mechanical Protection System (MPS). In principle, each such magnetic core will become a shell-type, booster transformer with a 1:1 ratio. The piggyback cable will constitute the primary winding, while the pipeline will constitute the secondary winding of this 1:1 shell-type transformer. This transformer configuration will thus act to ensure that the pipeline current is of similar magnitude to the piggyback cable current. Shell-type transformers are well known from use in high-current, low-voltage applications such as smelting plants.

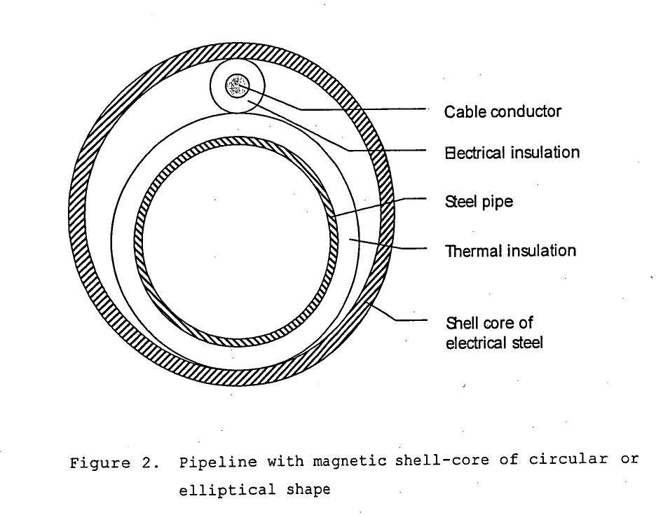

FIGS. 2-4 below present cross-sectional views of alternative configuration based on the same principal solution. The magnetic, shell-type core encompasses both piggyback cable and pipeline, and will thus work to balance out the difference in current in these two

conductors/windings.

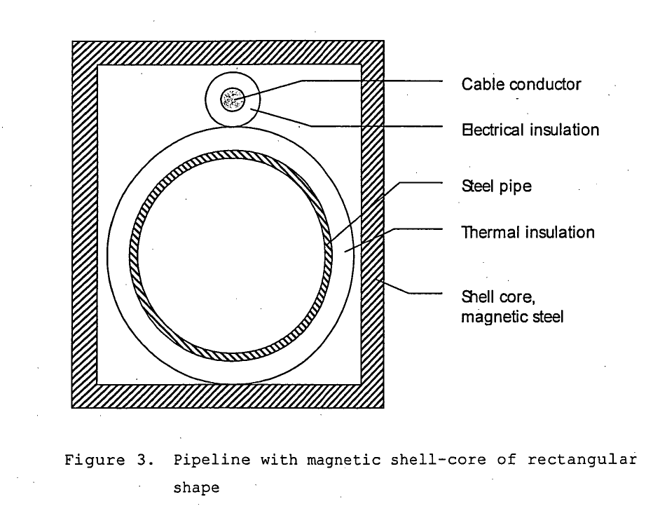

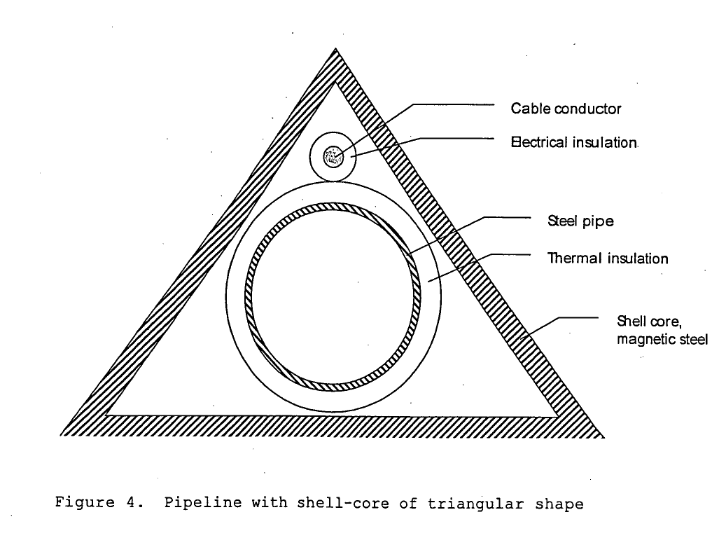

The circular/elliptical core shape in FIG. 2 will typically have the lowest magnetic reluctance for a given core thickness. The rectangular shape in FIG. 3 may have merits with respect to practical manufacturing aspects. The triangular shape in FIG. 4 will be less inclined to move sideways or roll/tip over during and after installation.

When a shell core of magnetic steel is applied in a continuous manner such that in encompasses pipeline and piggyback cable, it will also provide protection against mechanical impact for all elements inside.

Different practical methods for applying the magnetic shell core are feasible. Conventional flat-rolled electrical steel (supplied as coils) is normally used to build a laminated, magnetic core. The required amount of electrical steel, and thus the thickness of the shell core, will primarily depend on cable current and power frequency and must be dimensioned for each case. The dimensioning shall ensure that the magnetic shell-core yields a satisfactory magnetic reluctance, and also that it is not pushed into magnetic saturation, as this would conflict with its purpose.

The perhaps easiest method to envision is an additional process during pipeline installation in which coiled steel is wound onto the pipeline with piggyback (and MPS).

In either case some sort of non-metallic bobbin should simplify the work. Steel corrosion aspects are also expected to influence the packaging and surface treatment of the completed core.

Another method is to manufacture the core elsewhere, on a shaped bobbin with adequate inside dimensions to fit around the completed pipeline with piggyback and any additional mechanical cable protection system (if used). In this case it will be necessary to split the manufactured core axially to allow mounting onto the pipeline, and the efficiency of the core will be reduced by the air gaps introduced by such splitting. Shell core shapes as shown in FIG. 2-4 are still applicable. Again, corrosion aspects are expected to dictate the detailed core design and manufacturing methods.

Subsea pipelines will normally be equipped with sacrificial anodes for conventional (direct current, d.c.) corrosion protection. These anodes are in metallic contact with steel pipeline simultaneously as they are exposed to sea water. The distance between anodes may vary considerably from pipeline to pipeline. Some pipelines may have anodes distributed evenly along the full length, while others may have banks of anodes at the ends only.

The presence of distributed anodes along the pipeline will also influence the alternating current (a.c.) flow along the pipeline, and thus influence the heating effect obtained in the pipeline. Any anode represents a potential current leakage from pipeline to/from sea water.

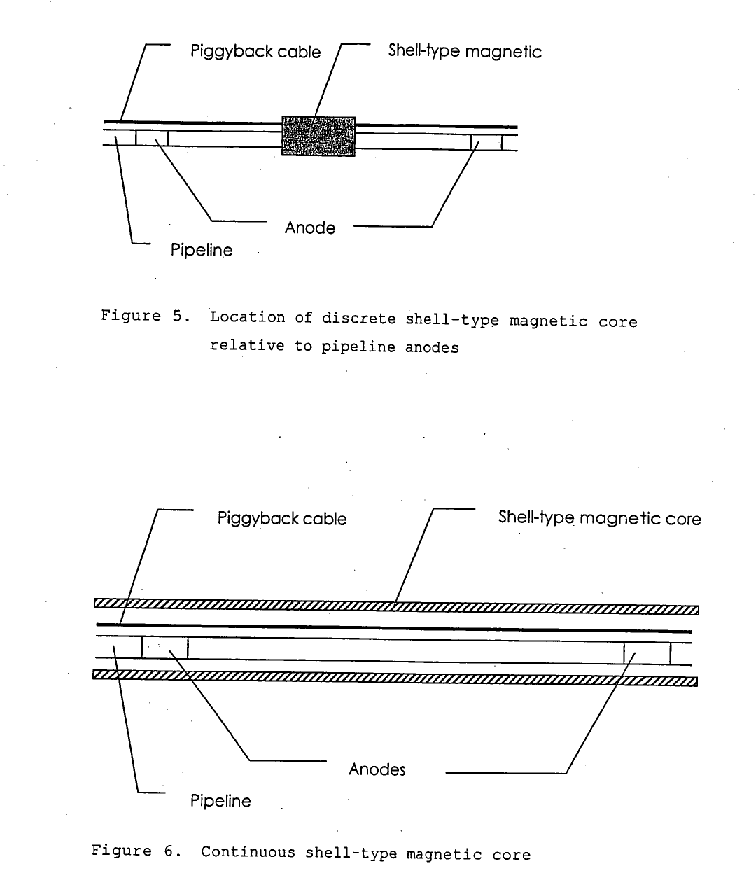

FIG. 5 illustrates an advantageous embodiment of the invention where at least one magnetic core is placed in between every pair of pipeline anodes. This will greatly prevent or reduce ‘loss’ of pipeline a.c. current into sea water at the anodes.

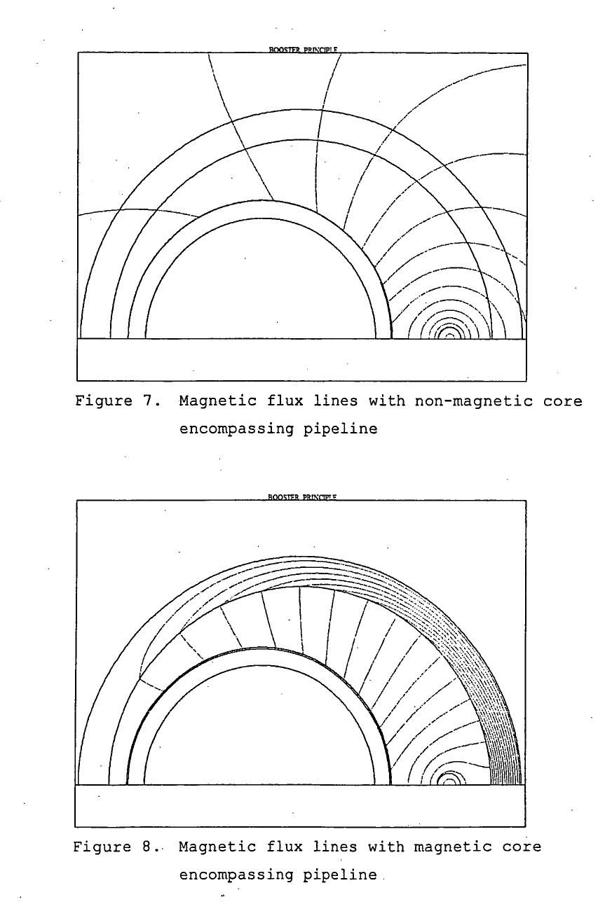

FIGS. 7 and 8 present the magnetic flux lines are shown for two cases below; a non-magnetic core, and a (moderately) magnetic core. As can be seen, the latter case produces near zero flux outside the core.

The present invention strongly reduces current flow in sea water compared to the best prior art solution(s), as current is shifted into the pipeline. As a consequence, given that the pipeline current is the dimensioning quantity for direct electric heating systems, the cable current and topside electrical power will be significantly reduced.

1. Direct electric heating system for subsea steel pipeline comprising:
a piggyback cable arranged on the pipeline;
an electric power supply unit arranged at a topside structure; and
supply cables, wherein at least one shell-type magnetic core encompasses the pipeline with its piggyback cable.

2. System according to claim 1, where the at least one shell-type magnetic core is continuously arranged on the pipeline, extending along essentially the whole length of the pipeline.

3. System according to claim 1, where the at least one shell-type magnetic core is discretely arranged on the pipeline extending along a limited part of the pipeline.

4. System according to claim 1, wherein the at least one shell-type magnetic core is constructed as a thin, continuous element of electrical steel.

5. System according to claim 4, wherein the continuous element has a thickness substantially similar to that of the pipeline.

6. System according to claim 1, wherein the at least one shell-type magnetic core is constructed as a discrete element of electrical steel where, for similar applications, the thickness of the discrete element is larger than the thickness of the continuous element.

7. System according to claim 1, where at least one magnetic core is arranged on every pipeline section as defined by pairs of distributed pipeline anodes.

8. System according to claim 1, where the shell-type magnetic core is laminated and includes electrical steel.

9. System according to claim 1, where the at least one shell-type magnetic core is designed not to saturate magnetically at maximum direct electric heating current.

10. System according to claim 1, wherein the shell-type magnetic core further comprises two axially divided halves to allow mounting around a continuous pipeline with piggyback cable.

11. System according to claim 1, where the shell-type magnetic core has a circular or oval shape in any radial cross-section.

12. System according to claim 1-10, where the shell-type magnetic core has a rectangular or triangular shape in any radial cross-section.

13. System according to claim 1, where the shell-type magnetic core provides protection against mechanical impact for all elements inside.

14. Method for applying shell-type magnetic core on a pipeline in a direct electric heating system according to claim 1, including the step of:
winding electrical steel around the pipeline with piggyback cable during installation.

15. Method for applying shell-type magnetic core on a pipeline in a direct electric heating system according to claim 1, including the steps of:
prefabricating the cores in axially divided halves; and
mounting the halves of the cores during pipeline installation.
